(19) United States
(12) Patent Application Publication
(10) Pub. No.: US 2005/0286526 A1
(43) Pub. Date: Dec. 29, 2005

(54) Optimized algorithm for stream re-assembly

(76) Inventors: Sanjeev H. Sood, San Diego, CA (US); Abhijit S. Khobare, San Diego, CA (US); Yunhong Li, San Diego, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/877,465

(22) Filed: Jun. 25, 2004

(51) Int. Cl. G08C 15/00

(52) U.S. Cl. 370/394; 370/412

(57) ABSTRACT

A mechanism is provided to receive out-of-order packets and to use a table to place the out-of-order packets in a queue so that the packets are queued in order of a sequence in which the packets were sent.

### BACKGROUND

Communication exchanges between components in a network can be unreliable. Packets can be lost or destroyed, e.g., due to transmissions errors, hardware malfunctions or network overload conditions. In addition, networks that route packets can change routes, delay packet delivery or deliver duplicate packets. For these and other reasons, network protocols do not assume that packets will arrive in the correct order.

To handle out-of-order deliveries, some network protocols, in particular, those that support segmentation (or fragmentation) and re-assembly, use some type of mechanism to maintain packet order. Transport protocols like Transmission Control Protocol (TCP), for example, attach sequence numbers to packet data and re-sequence the received packets to preserve the sequencing order in the received data. A receiving TCP may re-sequence such out-of-order packets (defined by TCP as “segments”) using a re-assembly queue, and pass the received data in the correct order to the appropriate application.

Many TCP implementations, including the popular Linux and Berkeley Software Distribution (or “BSD”) Unix operating systems, maintain a doubly-linked list based re-assembly queue of received segments. They employ a sequential search algorithm that traverses the re-assembly queue element by element to find the correct location (within the re-assembly queue) for inserting a newly received out-of-order segment.

### DESCRIPTION OF DRAWINGS

FIG. 1 is a communications system in which a sending device sends packets over a network to a receiving device (or receiver), where the packets arrive out-of-order.

FIG. 2 is a block diagram showing a portion of the receiver, in particular, a re-sequencing process that uses a re-assembly queue and an out-of-order table to re-sequence out-of-order packets.

FIG. 3 is a depiction of an exemplary re-assembly queue.

FIG. 4 is a depiction of an exemplary out-of-order table and out-of-order table entry format.

FIG. 5A is a block diagram of an exemplary receiver in which the re-sequencing process is implemented by a Transmission Control Protocol/Internet Protocol (TCP/IP) stack that executes on a general purpose processor.

FIG. 5B is a block diagram of an exemplary receiver in which the re-sequencing process is implemented by a TCP offload engine (TOE).

FIGS. 6A-6C are diagrams illustrating example re-assembly data structure updates resulting from re-assembly queue TCP segment insertions.

FIG. 7 is a flow diagram illustrating the re-sequencing process according to an exemplary embodiment.

FIG. 8 is a block diagram of an exemplary network processor system configurable as a TOE.

FIG. 9 is an illustration of data plane processing, including TCP offload processing, for packets received by the network processor shown in FIG. 8.

FIG. 10 is a diagram of an exemplary network environment in which multiple TOEs are employed.

Like reference numerals will be used to represent like elements.

### DETAILED DESCRIPTION

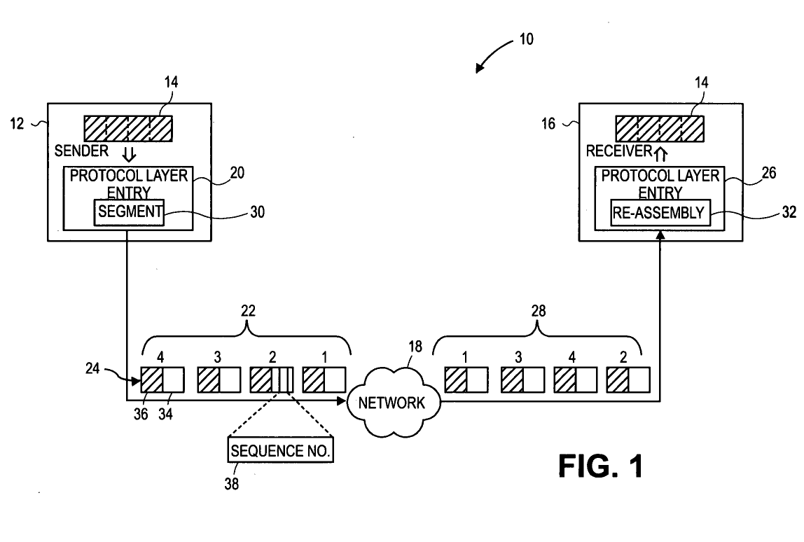

Referring to FIG. 1, a communications system 10 includes a sending system (or sender) 12 that sends information 14 to a receiving system (or receiver) 16 over a network 18. The network 18 represents a network that can include any number of different network topologies and technologies, such as wired, wireless, data, telephony and so forth. A protocol layer entity 20 in the sender 12 partitions the information 14 so that the information is provided to the network 18 in a sequence 22 of packets 24 for delivery to its destination, a peer protocol layer entity 26 in the receiver 14. The sequence defines the order of the packets. The packets 24 may arrive at the protocol layer entity 26 out-of-sequence (or out-of-order), as indicated by reference numeral 28. The protocol layer entity 26 performs a re-sequencing (or re-ordering) of the out-of-order packets to restore the order of the sequence 22 in which the packets were provided to the network 18 by the sender 12. To support the partitioning and subsequent re-sequencing/re-assembly of the information, the sender's protocol layer entity 20 includes a segmentation (or fragmentation) facility 30 and the receiver protocol layer entity 26 includes re-assembly facility 32. The terms “segmentation” and “fragmentation” refer to a process of partitioning information into smaller units at the sending end of a communication before transmission. The term “re-assembly” refers to a process of reconstructing the information from the smaller units in the proper order at the receiving end of the communication.

The information 14 that is presented for partitioning may include a packet payload or data from an application (e.g., a byte stream or messages). The information is partitioned into smaller units, which are encapsulated in packets. Each packet includes a header 34 followed by a payload 36 that carries a unit of the partitioned information. Each header 34 includes order information 38, e.g., a sequence number (as shown) or count, or offset value, which may be used to determine the relative order of the packet in the sequence. The receiver 16 uses the order information 38 to re-sequence the packets, and then reconstructs the information that was partitioned at the sender from the payloads of the re-ordered packets (using the re-assembly facility 32).

The term “packet” is generic and is intended to refer to any unit of transfer that is exchanged between peer protocol layer entities, as illustrated in the figure. Protocols define the exact form of packets used with specific protocol layer entities. If the protocol implemented by the protocol layer entities, 20, 26 is Transmission Control Protocol (TCP), for example, the information is application data stream data and the packets exchanged between peer TCP layers are TCP packets (also referred to as “segments”). If the protocol implemented by the protocol layer entities 20, 26 is Internet Protocol (IP), to give yet another example, and fragmentation is required to meet a maximum transmission unit (MTU) of the underlying network 18, the information to be partitioned is an IP packet (or IP datagram) and the packets exchanged between peer IP layers are IP fragments, which are smaller IP packets.

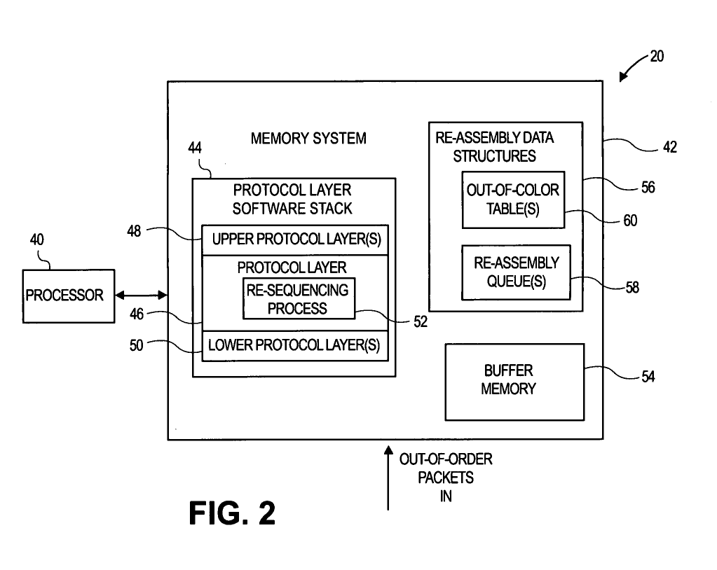

Referring to FIG. 2, the protocol layer entity 26 may be implemented by a processor 40 coupled to a memory system 42. The memory system 42 stores a protocol layer software stack 44 that includes a protocol layer 46 that can interface with one or more upper protocol layers 48 as well as interface with one or more lower protocol layers 50. The protocol layer 46 includes a re-sequencing process 52 (which may be part of the re-assembly facility 34, shown in FIG. 1) to re-order out-of-order packets received by that protocol layer for processing. A portion of the memory system 42 is used as buffer memory 54 to store incoming out-of-order packets. Another portion of the memory system 42 is organized as re-assembly data structures 56, including at least one re-assembly queue 58 and at least one corresponding table referred to herein as an out-of-order (OFO) table 60. The re-assembly queue 58 serves to link together the packets (in buffer memory 54) in order. The OFO table 60 provides information that enables the correct insertion location within the re-assembly queue to be determined for each of the received packets stored in the buffer memory 54 without accessing the re-assembly queue. These re-assembly data structures 58, 60 are maintained by the re-sequencing process 52, as will be described.

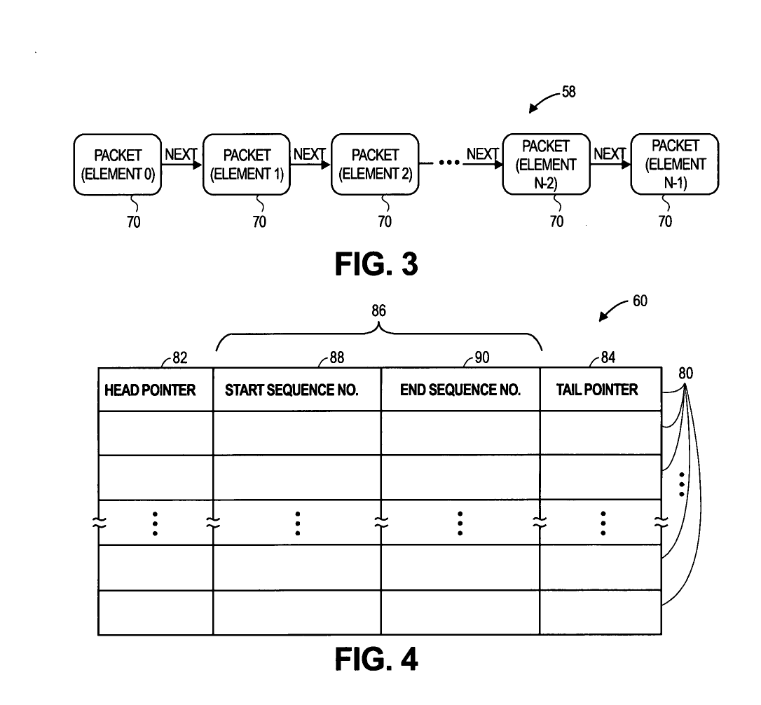

In one exemplary embodiment, as illustrated in FIG. 3, the re-assembly queue 58 is implemented as a single linked list of elements 70. Each element 70 corresponds to and thus provides information about a packet stored in the buffer memory 54 (from FIG. 2). At minimum, each element 70 stores a pointer to the next list element and a pointer to (or address for) the buffer memory location in which the corresponding packet is stored. Other information may be stored in the list elements as well.

The re-sequencing process 52 maintains information about the re-assembly queue 58 in a corresponding OFO table 60. The re-sequencing process 52 uses the OFO table 60 to logically divide the re-assembly queue 58 into sublists (or groups) at points in the queue linked list corresponding to gaps (in sequence numbering) in the sequence. Referring to FIG. 4, the OFO table 60 includes entries 80 each corresponding to a sublist. Initially, a sublist will include a single packet and will subsequently expand to include other packets as more packets are received. The packets in each sublist are contiguous—that is, the packets represent a span of consecutive sequence numbers. The number of table entries and corresponding sublists will grow with the number of gaps that occur in the sequence of the queue list as out-of-order packets are received. Gaps in the ordering of the sequence occur when adjacent elements in the queue list represent noncontiguous packets.

According to an exemplary format, shown in FIG. 4, each table entry 80, corresponding to a sublist, as described above, includes a head pointer 82 pointing to the first packet in that sublist and a tail pointer 84 pointing to the last packet in that sublist. If the sublist includes only one packet so far, the head and tail pointers will point to the same packet (or, more accurately, the element that points to that packet). Each table entry 80 also stores order information 86. As illustrated, the order information 86 may include a start sequence number 88 and an end sequence number 90 for the packet or packets in the sublist. In a TCP implementation, for example, in which each TCP segment carries in its payload one or more bytes and a header that identifies the sequence number of the first byte in the payload, the start sequence number is the sequence number of the first byte in the first segment payload and the end sequence number is the sequence number of the last byte in the last segment payload (or the last byte in the same segment payload, if only one segment). Thus, each entry can be viewed as a descriptor for the sublist to which it corresponds. To facilitate the search of the OFO table 60, as will be described, the end sequence number 90 may be provided as the sequence number of the last byte incremented by one to indicate the next expected sequence number in the sequence.

When a new out-of-order packet arrives, a linear search is performed on entries in the OFO table to find an appropriate re-assembly queue linked list insertion point for correct ordering. The new packet will either extend, or cause a gap to be created at, the head or tail of a sublist described by an existing OFO table entry 80. Thus, the packet can be inserted in the re-assembly queue 58 by using the head or tail pointer of the sublist entry, or by creating a new sublist that is adjacent (in the queue linked list) to the sublist and by adding a table entry that describes the new sublist. To insert a packet into the linked link of the re-assembly queue 58 so that the packet appears in the correct position, therefore, the re-sequencing process 52 does not search the re-assembly queue itself. Rather, the re-sequencing process 52 optimizes the search activity by limiting it to only the OFO table entries 80.

The protocol implemented by the protocol layer 46 may be any protocol that performs a re-ordering or re-sequencing of incoming packets. Protocols that require some type of re-sequencing/re-assembly support include TCP, Stream Control Transmission Protocol (SCTP), and IP, to give but a few examples. TCP and SCTP are both transport protocols that provide reliable transport services, thus ensuring that data is transported across the network in sequence (and without error). Unlike TCP, which is byte-stream-oriented and ensures byte sequence preservation, SCTP is message-oriented and allows messages to be transmitted in multiple streams. SCTP also supports a sequence numbering scheme, but uses sequence numbering to keep track of messages and streams. In a TCP or SCTP implementation, a re-assembly queue and OFO table would be maintained for each for each endpoint-to-endpoint connection. In an IP fragmentation/re-assembly context, the re-assembly data structures would be maintained for each IP datagram to be re-assembled from the IP fragments.

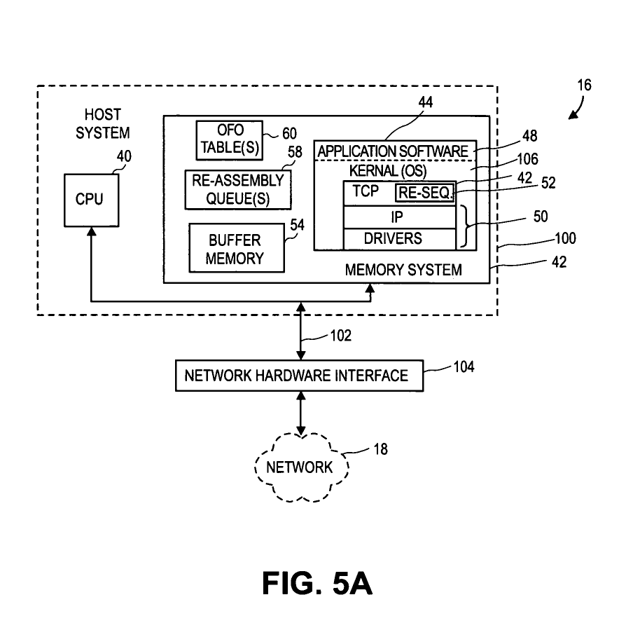

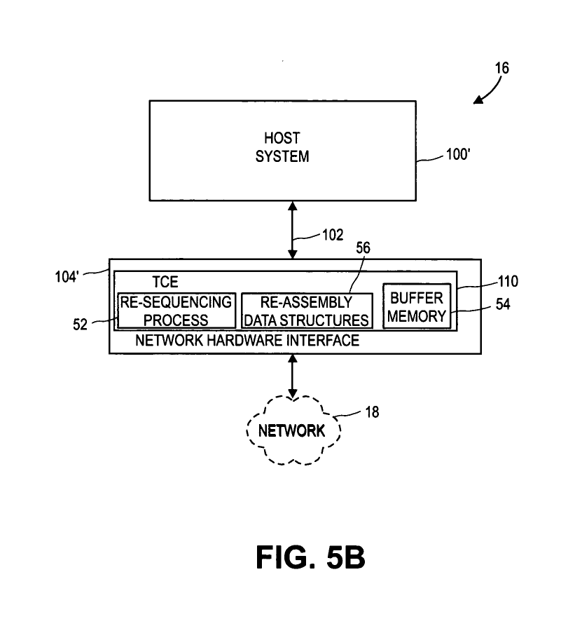

For the purposes of illustration, FIGS. 5-9 show the re-sequencing mechanism in a TCP/IP environment. FIGS. 5A-5B show two different embodiments of the TCP re-sequencing—one in an operating system context (FIG. 5A) and the other in a system configuration in which at least some of the TCP processing, including the re-sequencing, is offloaded to a TCP offload engine (TOE) (FIG. 5B).

As was mentioned earlier, TCP views the data stream as a sequence of bytes. In the TCP layer of the sending device, TCP divides the bytes of the data stream provided by the sending application into segments for transmission. Each segment may include one or more bytes, not to exceed a maximum segment size (MSS). Segments may not arrive at their destination in their proper order, if at all. For example, different segments may travel different paths across the network. Thus, the bytes in the data stream are numbered sequentially. Each segment includes a header followed by data (that is, the segment's payload). Included in the header is a sequence number that identifies the position in the sender's byte stream of the first byte of data in the segment. All segments exchanged by the TCP software of sender and receiver need not be the same size. In fact, all segments sent across a given connection need not be the same size. The IP layer encapsulates each segment in an IP datagram. The IP datagram or packet may be subject to further partitioning (a process referred to as “fragmentation” in the Internet Model) based on a maximum packet size restriction imposed by the underlying physical network.

Referring to FIG. 5A, the protocol layer software stack 44 in the receiver 16 is shown as a TCP/IP software stack that includes a TCP layer as protocol layer 46, an application layer as the upper layer 48, and an IP layer and a network interface layer (shown as drivers) as the lower protocol layers 50. The processor 40 is shown here as a central processing unit (CPU) 40, which executes a general purpose instruction set. The CPU 40 and memory system 42 may be part of a host system 100, as shown. The host system 100 is connected to an external interconnect 102, which couples the host system 100 to a network hardware interface 104. The TCP/IP layers and drivers may be part of a host operating system (OS) 106, for example, Linux OS or Berkeley Software Distribution (BSD) Unix OS.

The re-sequencing technique applies not only to general TCP implementations (such as the one illustrated in FIG. 5A), but to TCP offload implementations as well. Because TCP/IP traffic requires significant host resources, specialized software and hardware known as a TCP offload engine (TOE) can be used to reduce host CPU utilization. The TOE technology includes software extensions to existing host TCP/IP stacks. A TOE allows the host OS to offload some or all of the TCP/IP processing to the TOE. In a partial offload, the host may retain the control decisions, e.g., those related to connection management and exception handling, and offload the data path processing, e.g., data movement overhead, to the TOE. This type of offload is sometimes referred to as a “data path offload” (DPO). Alternatively, in a full offload scheme, the host OS may offload TCP control and data processing to the TOE.

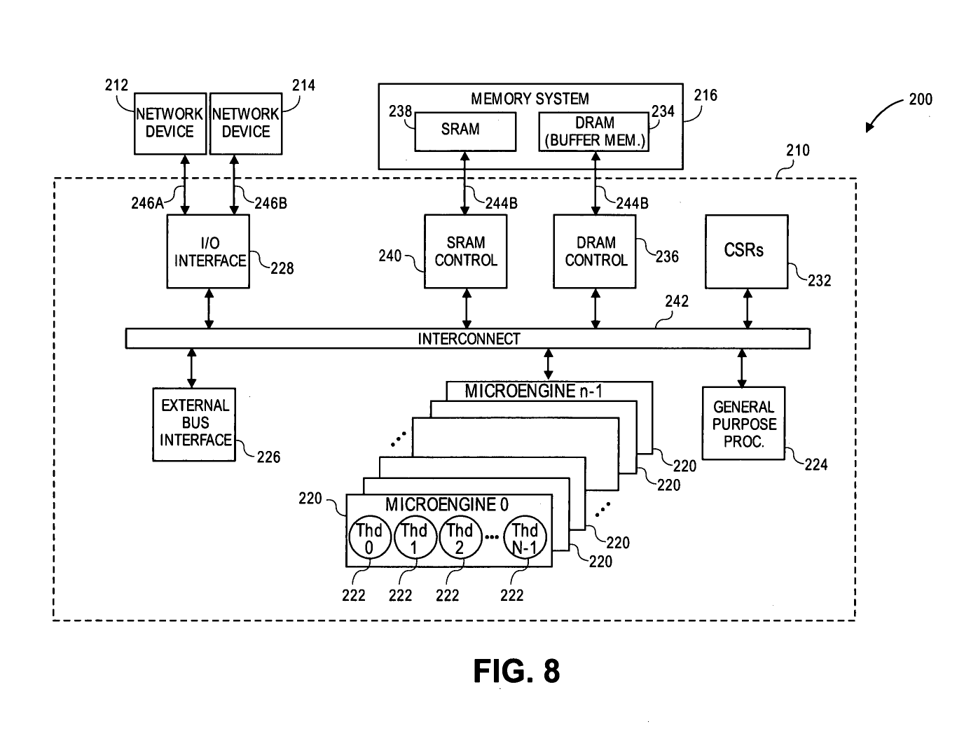

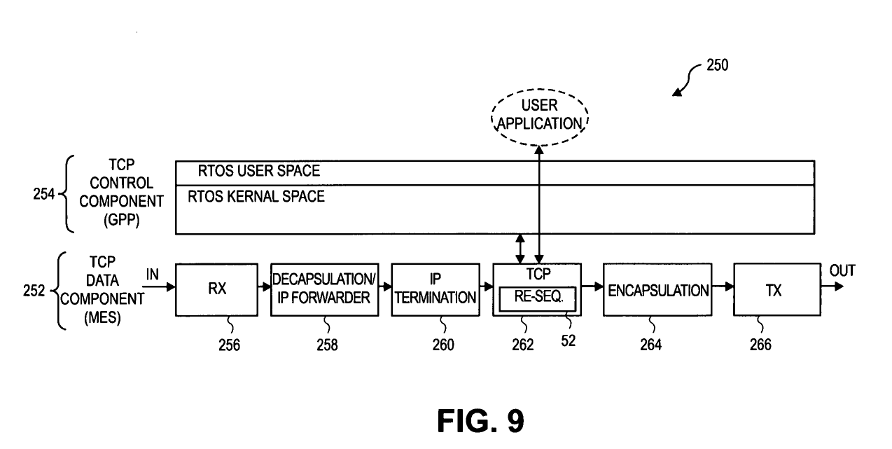

Referring to FIG. 5B, the receiver 16 from FIGS. 1-2 is implemented by a host system 100′ that is coupled to a network hardware interface (or network adapter) 104′ configured to operate as or include a TOE 110. In this example, the re-sequencing process 52, re-assembly data structures 56 (including re-assembly queue 58 and OFO table 60) and buffer memory 54 reside on the TOE 110. Although not shown in this figure, it will be appreciated that at least a portion of the TCP/IP software suite is duplicated in the TOE. The TOE TCP offload functionality could reside by itself on a separate network accelerator card instead. Details of an exemplary firmware-based approach to the TOE 110 for full offload capability will be described later with reference to FIGS. 8-9.

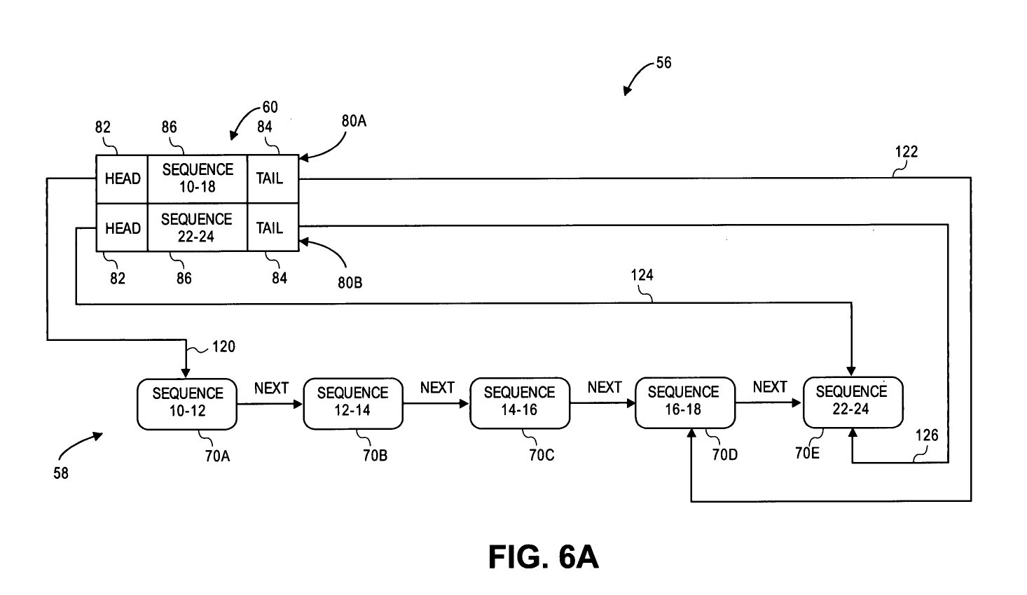

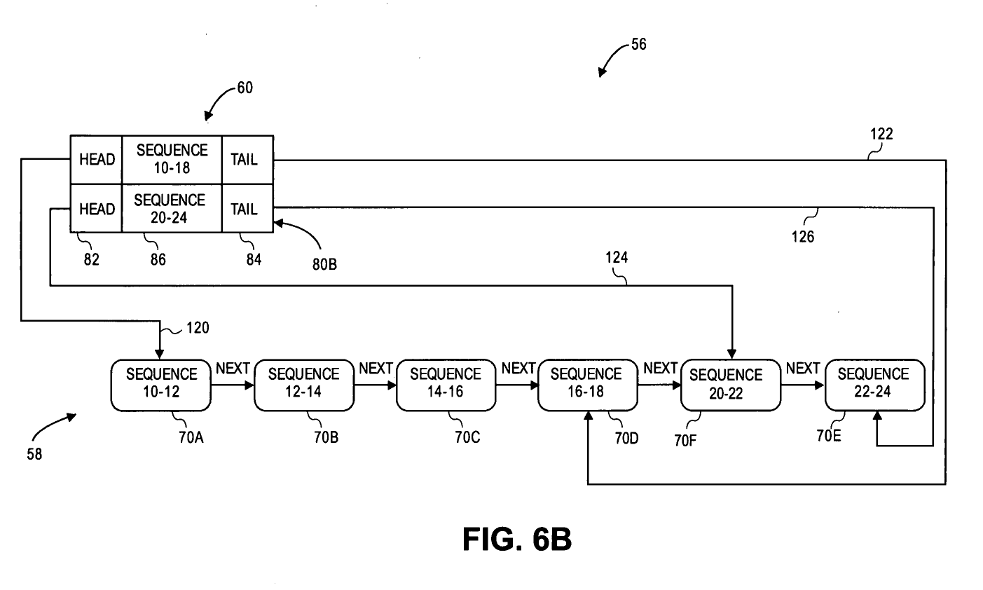

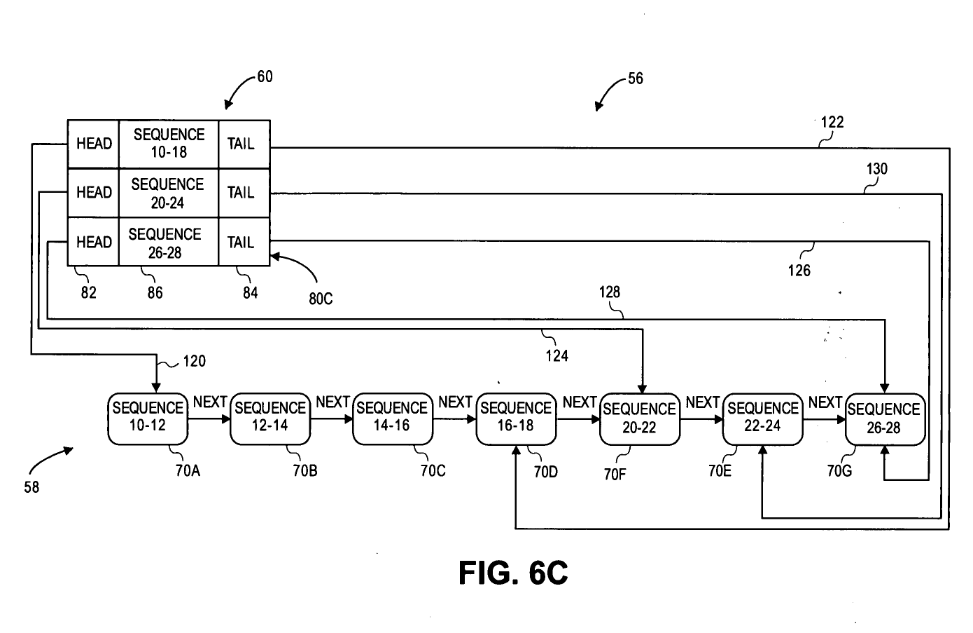

FIGS. 6A-6C show re-assembly data structure update examples for TCP. For these examples, assume that the data structure used for the OFO table entry is defined as the following:

structure ofo_table_entry {

| | |
|---|---|
| char *entry.head_seg; | /* pointer to the first segment in the sublist */ |
| u_int *entry.seq; | /* starting sequence number of the sublist */ |
| u_int *entry.enq; | /* end sequence number of the sublist */ |
| char *entry.tail_seg; | /* pointer to the last segment in the sublist */ |
| } | |

Also assume that each segment is the same size and carries two bytes of data stream data in its payload.

Referring to the example shown in FIG.6A, the OFO table 60 includes two entries, first entry 80a and second entry 80b, and the re-assembly queue 58 includes five elements 70a, 70b, 70c, 70d and 70e corresponding to five TCP segments. In this example, there are two gaps in the segment sequence represented by the list of the re-assembly queue. The first gap is between the segment represented by element 70a and a preceding segment (or segments) received in order. That is, the first element 70a represents an out-of-order segment. Because the re-assembly queue is an out-of-order queue, there is always a gap at the start of the re-assembly queue. The second gap occurs between segments represented by elements 70d and 70e. The first entry 80a groups together the first four segments, segments 70a, 70b, 70c, and 70d in a first sublist since those segments are contiguous. They are represented in the table entry 80a by start and end sequence numbers (10 and 18, respectively, in the order information 86 of the example shown), and pointers to the first and last segments. As shown, the header pointer 82 points to the first segment 70a (as indicated by arrow 120) and the tail pointer 84 points to the last segment 70d (as indicated by arrow 122). There are four bytes missing between the segment 70d (with sequence nos. 16-18), which is the last segment in the group of four segments pointed to by the first OFO table entry 80a, and segment 70e (with sequence nos. 22-24), which belongs to a second sublist and is pointed to the second OFO table entry 80b. The head pointer 82 and the tail pointer 84 in entry 80b point to the segment 70e, as indicated by arrow 124 and 126, respectively.

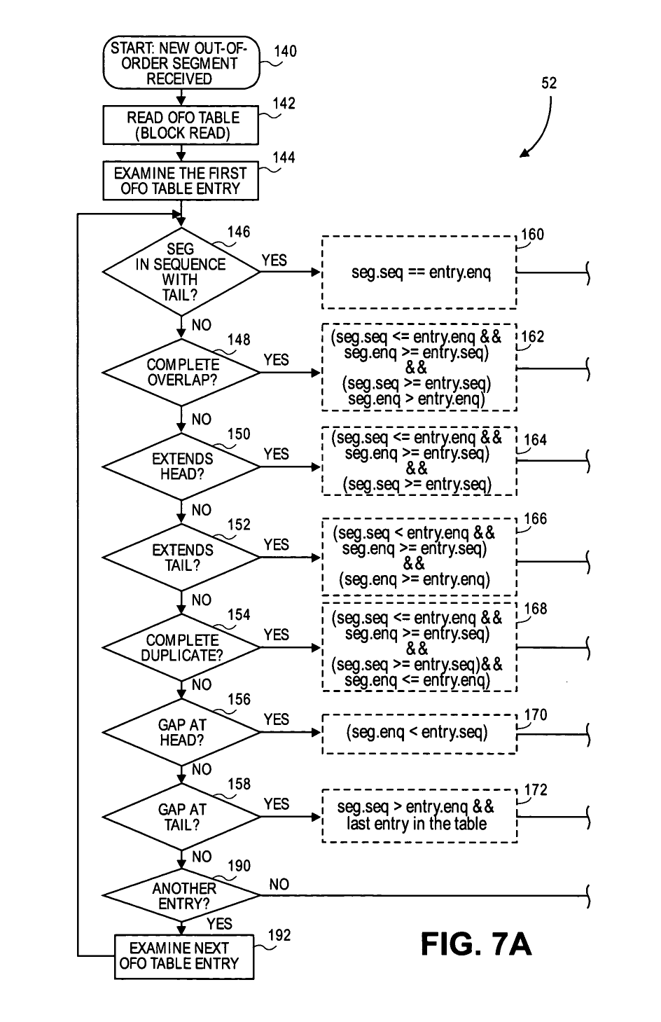

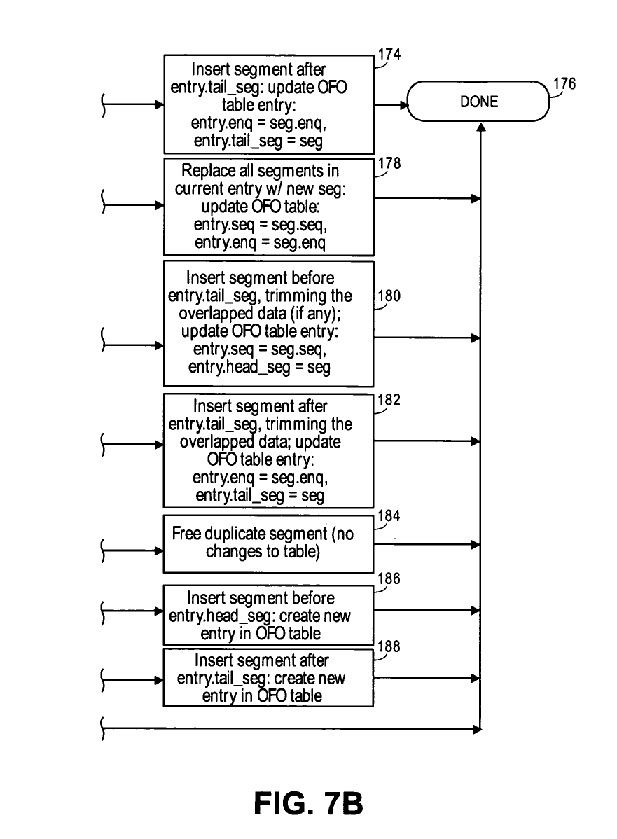

When a new segment with a start sequence number (“seg.seq”) of 20 and an end sequence number (“seg.enq”) of 22 is received, the table entries 80a, 80b are searched to find the appropriate insertion location. Note that the end sequence number of the segment, as in the table entries, is the actual end sequence “21” incremented by one, that is, “22”. Incrementing the actual end sequence number in this fashion allows the sequence numbers of packets to be compared for matches, as will be described later with reference to FIG. 7.

Still referring to FIG. 6A, the start sequence number “seg.seq=20” indicates that the new segment is after the segment pointed to by the tail pointer (“entry.tail_seg”) 84 of the first entry 80a, that is, tail segment 70d. An examination of the second entry 80b reveals that the new segment is in sequence with the segment pointed to the head pointer (“entry.head_seg”) of that entry, head segment 70e. For the new segment to be in sequence with the head segment, the head segment must succeed the new segment according to the order of the sequence numbering contained in the segments. There is no gap in sequence numbering between the new segment and the head segment. Thus, the new segment will be inserted in the list before the head segment 70e of the second entry 80b.

After the new segment insertion, the re-assembly queue 58 and OFO table 60 will appear as shown in FIG. 6B. The sublist pointed to be the second entry has been extended at the head to include new segment 70f. There remains a gap between the second sublist, which includes new segment 70f and segment 70e, and the first sublist (pointed to by the first entry 80a), which includes segments 70a through 70d. The head pointer 82 of the second entry 80b has been changed to point to the new segment 70f instead of the last segment 70e (as indicated by the arrow 124) and the start sequence number of the order information 86 (more specifically, the start sequence number field 88, shown in FIG. 4) has been changed to the sequence number of the first byte in the new segment (that is, “seg.seq=22” has been changed to “seg.seq=20”).

Now it may be helpful to examine a case where the insertion of a new segment creates a new gap in the queue list. To illustrate this case, assume that the data structures are as shown in FIG. 6B at the outset and that a new segment 70g with “seg.seq=26” and “seg.enq=28” is received. Since there is a gap in the sequence numbering between the segments in the sublist pointed to by the second OFO table entry 80b and the new segment 70g, a new table entry 80c needs to be added to the OFO table 60.

FIG. 6C shows the re-assembly queue 58 and OFO table 60 after the insertion of the new segment 70g at the end of the re-assembly queue 58. The OFO table 60 has been updated to include a third table entry 80c corresponding to the newly inserted segment 70g. The third table entry 80c includes a head and tail pointer that point to that segment (as indicated by arrow 128 for the head pointer 82 and arrow 130 for the tail pointer 84). The start and end sequence numbers in the order information 86 (more specifically, the start and end sequence number fields 88 and 90, from FIG. 4) of the new entry 80c are written with the segment's start and end sequence numbers (for the two bytes contained in the segment), that is sequence numbers 26 and 28, respectively.

Referring to FIG. 7, details of the re-sequencing process 52 for a new segment to be inserted into the re-assembly queue 58 are shown. The process 52 begins 140 when a new “out-of-order” segment is received. The process 52 reads 142 the OFO table. The table read may be performed as a block read operation, i.e., a read operation that copies the table in its entirety into a local memory or cache. The process 52 examines 144 the first table entry corresponding to a first sublist of one or more elements in the re-assembly queue. The re-sequencing process 52 performs one or more checks, indicated by reference numerals 146, 148, 150, 152, 154, 156, 158, on the contents of the table entry. Results of these checks 146, 148, 150, 152, 154, 156, 158 are indicated by reference numerals 160, 162, 164, 166, 168, 170, 172 (dashed boxes), respectively. The process 52 first determines 146 if the segment is in sequence with the tail (that is, the tail of the sublist represented by the table entry). To be in sequence with the tail, the new segment carries the next expected sequence number for the sequence of that sublist. If the segment is determined to be in sequence with the tail, then the segment sequence number is equal to the end sequence number (“seq.seq”=“entry.enq”, as indicated at 160). If the segment is in sequence with the tail of the entry, the process 52 modifies 174 the re-assembly data structures. More specifically, the process 52 inserts the segment into the linked list after the tail segment (pointed to by the tail pointer “entry.tail_seg”) and updates the OFO table entry by changing the end sequence number in the entry (“entry.enq”) to the end sequence number of the new segment (“seg.enq”) and modifying the tail pointer (“entry.tail_seg”) to point to the new segment (“entry.tail_seg=seg”). Once these updates are completed, the process terminates 176.

If, at 146, it is determined that the segment is not in sequence with the tail, the process 52 determines if the new segment completely overlaps one or more segments represented by the entry. As indicated at 162, a complete overlap is detected if both of the following conditions are met: i) the start sequence number of the new segment is less than or equal to the end sequence number in the entry, and the end sequence number of the new segment is greater than or equal to the entry start sequence number (“seg.seq entry.enq” AND “seq.enq entry.seq”); and ii) the start sequence number of the new segment is less than the start sequence number in the entry, and the end sequence number of the new segment is greater than the entry end sequence number (“seg.seq<entry.seq” AND “seq.enq>entry.enq”). A complete overlap situation could occur if, for example, two segments are received and the receiver's acknowledgement for one segment is delayed or dropped, causing the sender to re-transmit a combined segment that combines the data from both segments. In such a case, the new combined segment would completely overlap the two original segments.

Still referring to FIG. 7, if a complete overlap is determined to exist, the process 52 modifies 178 the re-assembly data structures by replacing all segments in the current entry with the new segment and also updating the OFO table by changing the start sequence number in the entry to that of the new segment (“entry.seq”=seg.seq”) and changing the end sequence number in the entry to that end sequence number of the new segment (“entry.enq”=seg.enq”). Once these updates are complete, the process terminates at 176.

If, at 148, a complete overlap is not detected, the process 52 determines 150 if the segment extends the head of the sublist. If the segment extends the head, then it will mean that condition i) above will have been met along with a new second condition ii): the start sequence number of the new segment is less than the start sequence number in the entry (“seg.seq<entry.seq”), as indicated at 164. If the head is extended, the process modifies 180 the data structures by inserting the new segment into the list before the segment pointed to by the head pointer (that is, “entry.head_seg”), trimming any overlapped data (in the case of overlap, which occurs if the segment is not purely in sequence with the head), and updating the OFO table by changing the start sequence number in the entry to the start sequence number of the new segment (“entry.seq=seg.seq”) and updating the head pointer to point to the new segment as the new head (“entry.head_seg=seg”). The process 52 then terminates at 176. If the process 52 determines that the head is not extended, it checks 152 if the new segment extends the tail. If the segment extends the tail, then it will mean that both of the following conditions are met: i) the start sequence number of the new segment is less than the end sequence number in the entry, and the end sequence number of the new segment is greater than or equal to the entry start sequence number (“seg.seq<entry.enq” AND “seq.enq entry.seq”); and ii): the end sequence number of the new segment is greater than the end sequence number in the entry (“seg.enq>entry.enq”), as indicated at 166. If the tail is extended in this manner, the process 52 modifies 182 the re-assembly data structures by inserting the segment into the list after the segment pointed to by the tail pointer (“entry.tail_seg”), trimming the overlapped data, and updating the OFO table by changing the end sequence number in the entry to the end sequence number of the new segment (“entry.enq=seg.enq”) and updating the tail pointer to point to the new segment as the new tail (“entry.tail_seg=seg”). The process 52 then terminates at 176.

At this point, if none of the prior checks are successful, the process 52 determines 154 if new segment is a complete duplicate of an entry. A complete duplicate is detected if condition i) above, as described with respect to reference numeral 162, is satisfied and a second condition, testing if the start sequence number of the new segment is greater than or equal to the start sequence number in the entry and the end sequence number of the segment is less than or equal to the end sequence number of the entry (“seg.seq entry.seq AND seg.enq entry.enq”), is also satisfied, as indicated at 168. For example, a complete duplicate situation for a entry corresponding to only one segment could occur if the receiver's acknowledgement is delayed or dropped, causing the sender to re-transmit the segment. If both of these conditions are satisfied, indicating that the new segment is a complete duplicate of an existing entry, the process frees (or discards) 184 the duplicate segment. No changes to the OFO table are needed for this case. The process 52 terminates at 176.

If a complicate duplicate scenario is not found, the process 52 determines 156 if the insertion of the new segment would result in the creation of a gap at the head. If so, then the end sequence number of the new segment is less than the start sequence number in the entry (as indicated at 170, “seg.enq<entry.seq”). If a gap at the head is determined, the process 52 modifies 186 the re-assembly data structures by inserting the new segment in the queue list before the segment pointed to by the head pointer (“entry.head_seg”) and generates a new table entry for the new segment to establish a new sublist. Once the data structure updates are completed, the process 52 terminates at 176. If there is no gap at the head, the process 52 determines 158 if a gap is instead formed at the tail. Such a gap is detected if the start sequence number of the new segment is greater than the end sequence number in the entry, and the entry is the last entry in the table (“seg.seq>entry.enq AND last entry in the table”), as indicated at 172. If there is a gap at the tail, the process 52 modifies 188 the re-assembly data structures by inserting the new segment in the queue list after the segment pointed to by the tail pointer (“entry.tail_seg”) and creating a new table entry for the new segment. Once these updates are completed the process 52 terminates at 176.

If all of the checks fail (that is, the current table entry is not a “match” in the sense that it yields the correct insertion location), the process 52 proceeds to examine the next table entry (at 190) and repeats one or more of the checks 146, 148, 150, 152, 154, 156, 158 as necessary to find a match. This processing loop repeats until a match is found and the new segment can be inserted in the list at the appropriate location.

Several of the cases, “complete overlap” 148, “extends head” 150, “extends tail” 152 and “complete duplicate” 154, check that an incoming segment has at least some overlap with the current table entry. Other conditions and checks are performed to more fully determine the nature of that overlap, i.e., whether it is a complete overlap, an extension of the tail or head, or complete duplicate, in the manner described earlier.

It will be appreciated that, in the illustrated embodiment of FIG. 7, the “in sequence with tail” check (indicated at 146) is the first check to be performed as it is the most common case. Often one packet in a chain is lost, and following packets are still in sequence with the tail. Thus, although this case is later covered by the “extends tail” 152 check, this extra check saves some extra cycles for the common case. It is not as common for the incoming segment to be in sequence with head, so there is no extra check for this case as there is for the “in sequence with tail” case.

Thus, FIG. 7 illustrates operation of an algorithm that permits efficient ordering of TCP segments and packets for other types of protocols without employing a traditional sorting algorithm. The re-sequencing process 52 described above works well in TCP scenarios in which the re-assembly queue 58 is large but has only few gaps due to a couple of segments being dropped or re-ordered in the network. Such scenarios are fairly common. The search time does not increase with the new segments, but rather with each new gap. At some point, segments arrive to fill the gaps and the insert time becomes faster than the time required by the search.

In implementations that provide support for a local cache, the table read may be performed as a block read (as discussed earlier) and maintained in the local cache during processing. Thus, updates to the table could occur while the table resides in cache. The contents of the cache could then be written back to the more remote memory system once the processing is completed. During write-back, the table entries would be re-arranged (if necessary) so that the entries appear in the correct order. For example, a new entry resulting from a gap at the head would be made the new first entry and the old first entry would be made the second entry.

This re-sequencing process 52 requires only table accesses to determine queue insertion location. The more time-consuming accesses to the re-assembly queue itself need only be performed for the actual insertion (that is, the writes to queue list elements with pointers to buffer memory and pointers to next list elements).

The re-sequencing process 52 outperforms the conventional sequential queue search algorithm for average cases in terms of time complexity. The sequential queue search algorithm needs to traverse half the reassembly queue to find the correct insertion location on average. The re-sequencing process 52 keeps track of the sequence number gaps in the reassembly queue. Thus, it may need to traverse half the gaps on average. Assuming that, in the average case, the gaps in the re-assembly queue are half or less than the actual number of entries in the queue, the re-sequencing process 52 reduces the time complexity by half. For the best case and worst case, the time complexity of the two algorithms may be similar.

Memory accesses are frequently the gating factor for high throughput network protocol stacks, since memory latency is frequently difficult to hide The re-sequencing algorithm 52 cuts the time complexity by half as compared to sequential search, which translates to half as many memory accesses. The sequential search algorithm needs one memory access per traversal. On the other hand, the re-sequencing process 52 keeps track of the inter-sequence gaps in the OFO table. Since entries in a table are contiguous, it is possible to read multiple entries in one memory access. Thus, the re-sequencing process 52 has better than 50% improvement in terms of memory accesses. It should also be noted that fewer memory accesses can have the effect of reducing memory bandwidth and improving memory headroom, possibly resulting in overall system performance improvement.

FIG. 8 shows an example embedded system (“system”) 200 that may be programmed to operate as a TOE. The system 200 includes a network processor 210 coupled to one or more network I/O devices, for example, network devices 212 and 214, as well as a memory system 216. In one embodiment, as shown, the network processor 210 includes one or more multi-threaded processing elements 220 to execute microcode. In the illustrated network processor architecture, these processing elements 220 are depicted as “microengines” (or MEs), each with multiple hardware controlled execution threads 222. Each of the microengines 220 is connected to and can communicate with adjacent microengines. In the illustrated embodiment, the network processor 210 also includes a general purpose processor 224 that assists in loading microcode control for the microengines 222 and other resources of the processor 210, and performs other general purpose computer type functions such as handling protocols and exceptions.

In network processing applications, the MEs 220 may be used as a high-speed data path, and the general purpose processor 224 may be used as a control plane processor that supports higher layer network processing tasks that cannot be handled by the MEs 220.

In the illustrative example, the MEs 220 each operate with shared resources including, for example, the memory system 216, an external bus interface 226, an I/O interface 228 and Control and Status Registers (CSRs) 232, as shown. The I/O interface 228 is responsible for controlling and interfacing the network processor 210 to various external media devices, such as the network devices 212, 214. The memory system 216 includes a Dynamic Random Access Memory (DRAM) 234, which is accessed using a DRAM controller 236, and a Static Random Access Memory (SRAM) 238, which is accessed using an SRAM controller 240. Although not shown, the processor 210 also would include a nonvolatile memory to support boot operations.

The network devices 212, 214 can be any network devices capable of transmitting and/or receiving network traffic data, such as framing/MAC devices, or devices for connecting to a switch fabric. Other devices, such as a host computer and/or bus peripherals (not shown), which may be coupled to an external bus controlled by the external bus interface 226 can also serviced by the network processor 210. For example, and referring back to FIG. 5B, the host 100′ may be coupled to the TOE implemented by the network system 200 via bus 102 when the bus 102 is connected to the external bus interface 226. Thus bus 102 may be any type of bus, such as a Small Computer System Interface (SCSI) bus or a Peripheral Component Interconnect (PCI) type bus (e.g., a PCI-X bus).

Each of the functional units of the network processor 210 is coupled to an internal interconnect 242. Memory busses 244a, 244b couple the memory controller 236 and memory controller 240 to respective memory units DRAM 234 and SRAM 238 of the memory system 216. The I/O interface 228 is coupled to the network devices 212 and 214 via separate I/O bus lines 246a and 246b, respectively.

The network processor 210 can interface to any type of communication device or interface that receives/sends data. The network processor 210 could receive packets from a network device and process those packets in a parallel manner.

In the TOE implementation, the re-assembly data structures are stored in the SRAM 238 and the packets are stored in buffer memory in the DRAM 234. The OFO table are the SRAM 238 (or, alternatively, in a local scratch memory of the network processor), and optionally cached in local memory in the MEs during the re-sequencing process to reduce the time for and complexity of the memory accesses. The re-sequencing process is stored in an ME and executed by at least one ME thread.

FIG. 9 illustrates a TCP offload processing software model 250 for packets received by the network processor 210 shown in FIG. 8. Referring to FIG. 9 in conjunction with FIGS. 8 and 5B, the TOE 110 offloads transport functions from a host CPU in the host 100′. The microengines 220 provide a data plane component 252 for high performance TCP offload, while the general purpose processor 224 provides a TCP control plane component 254. The data plane component, which performs the tasks for packet receive (block 256), decapsulation (e.g., of the MAC frame), classification and IP forwarding (block 258), IP termination (block 260) and TCP data processing, including the re-sequencing process 52 (block 262), is run on the MEs 220. The control plane component 254, implemented by a Real-time Operating System (RTOS), runs on the general purpose processor (GPP) 224. Exception packets, which cannot be handled by the data plane and require special processing, are handled by the control plane component. In addition, the control plane component 254 handles TCP connection setup and teardown, and the forwarding of TCP data (post-re-sequencing/re-assembly by block 262) to the appropriate user application. Processing support for the transmit direction to provide user application data to the network could be included as well, as indicated by encapsulation block 264 and transmit block 266, in addition to TCP data processing block 262.

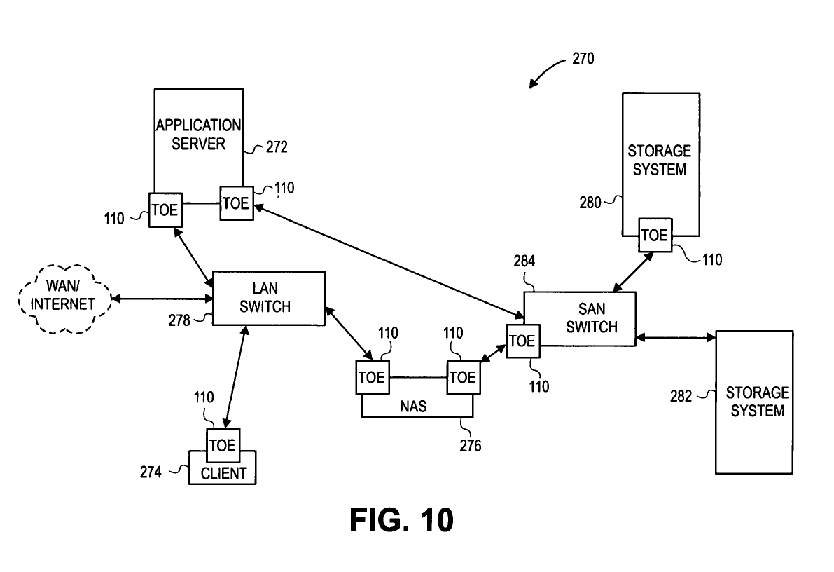

The TOE 110 may be employed in a variety of network architectures and environments. For example, as shown in FIG. 10, a network environment in which multiple TOEs are employed may include an enterprise network 270. The enterprise network 270 includes various devices, such as an application server 272, client device 274 and network attached storage device 276, that are interconnected via a LAN switch 278 to form a LAN. Similarly, storage systems 280 and 282, as well the network attached storage device 276 and application server 272, belong to a Storage Area Network (SAN) and are interconnected via a SAN switch 284. Each of units 272, 274, 276, 280 and 284 employs at least one TOE. Any one or more of the TOEs (or all of the TOEs, as shown) may be implemented according to the architecture of the TOE 110 (which, as illustrated in FIG. 5B, includes the re-sequencing process 52, along with the related re-assembly data structures and buffers). The enterprise network 270 may be connected to another network, e.g. a Wide Area Network (WAN) or Internet, as indicated. Examples of other types of devices that could use a sequencing mechanism include network edge devices such as IP routers, multi-service switches, virtual private networks, firewalls, network gateways and network appliances. Still other applications include iSCSI cards and Web performance accelerators.

The re-sequencing mechanism described above may be used by a wide variety of devices and applied to other protocols besides TCP, as discussed above. The mechanism may be used by or integrated into any protocol off-load engine that requires re-sequencing for re-assembly. For example, the off-load engine can be configured to perform operations for other transport layer protocols (e.g., SCTP), network layer protocols (e.g., IP), as well as application layer protocols (e.g., sockets programming). Similarly, in ATM networks, the off-load engine can be configured to provide operations to support Asynchronous Transfer Mode Adaptation layer (ATM AAL) re-assembly. Support for other protocols that do not require re-sequencing may be included in the offload engine as well.

Although shown as a software-based implementation, it will understood that some or all of the offload engine, including the re-sequencing mechanism 52, could be implemented in hardware, for example, with hard-wired Application Specific Integrated Circuit (ASIC) and/or other circuit designs. Again, a wide variety of implementations may use one or more of the techniques described above. Other embodiments are within the scope of the following claims.

1. A method comprising:
receiving packets delivered out-of-order by a network; and
using a table to place each packet received in a queue so that the packets are queued in order according to a sequence in which the packets were provided to the network by a sender.

2. The method of claim 1 wherein the packets include order information, associated with the packets by the sender, usable to determine the sequence.

3. The method of claim 2 wherein the order information in each packet comprises a sequence number.

4. The method of claim 3 wherein the queue comprises a linked list and the table divides the linked list into sublists at points in the linked list corresponding to gaps in the sequence.

5. The method of claim 4 wherein each sublist is represented by an entry in the table.

6. The method of claim 5 wherein each entry includes a head pointer to point to a first packet in the sublist and a tail pointer to point to a last packet in the sublist.

7. The method of claim 6 wherein the entry further includes a start sequence number associated with the first packet in the sublist and an end sequence number associated with the last packet in the sublist.

8. The method of claim 5 wherein using the table comprises:
searching the table for each packet after such packet is received, the searching beginning with a first entry and continuing with each successive entry until a matching one of the entries, one usable to determine a location at which such packet is to be inserted into the queue linked list, is found.

9. The method of claim 8 wherein searching comprises, for each entry searched, examining the entry to determine if the packet should be included in the sublist represented by the entry.

10. The method of claim 9 wherein searching further comprises updating the entry to reflect the inclusion of the packet in the sublist.

11. The method of claim 9 wherein searching further comprises examining the entry to determine if the packet is to be added to the queue linked list as a new sublist that is adjacent to the sublist in the queue linked list.

12. The method of claim 11 wherein searching further comprises updating the table to include a new entry to represent the new sublist.

13. The method of claim 1 wherein each packet comprises a TCP segment.

14. The method of claim 1 wherein each packet comprises an IP fragment.

15. The method of claim 2 wherein each packet comprises an IP fragment and the order information comprises an offset value.

16. An article comprising:
a storage medium having stored thereon instructions that when executed by a machine result in the following:
using a table to place packets, delivered out-of-order by a network, in a queue so that the packets are queued in order according to a sequence in which the packets were provided to the network by a sender.

17. The article of claim 16 wherein the packets include order information, associated with the packets by the sender, usable to determine the sequence.

18. The article of claim 17 wherein the order information in each packet comprises a sequence number.

19. The article of claim 18 wherein the queue comprises a linked list and the table divides the linked list into sublists at points in the linked list corresponding to gaps in the sequence.

20. The article of claim 19 wherein each sublist is represented by an entry in the table.

21. The article of claim 20 wherein each entry includes a head pointer to point to a first packet in the sublist and a tail pointer to point to a last packet in the sublist.

22. The article of claim 21 wherein the entry further includes a start sequence number associated with the first packet in the sublist and an end sequence number associated with the last packet in the sublist.

23. The article of claim 21 wherein using the table comprises:
searching the table for each packet after such packet is received, the searching beginning with a first entry and continuing with each successive entry until a matching one of the entries, one usable to determine a location at which such packet is to be inserted into the queue linked list, is found.

24. The article of claim 23 wherein searching comprises, for each entry searched, examining the entry to determine if the packet should be included in the sublist represented by the entry.

25. The article of claim 24 wherein searching further comprises updating the entry to reflect the inclusion of the packet in the sublist.

26. The article of claim 24 wherein searching further comprises examining the entry to determine if the packet is to be added to the queue linked list as a new sublist that is adjacent to the sublist in the queue linked list.

27. The article of claim 26 wherein searching further comprises updating the table to include a new entry to represent the new sublist.

28. The article of claim 16 wherein each packet comprises a TCP segment.

29. The article of claim 16 wherein each packet comprises an IP fragment.

30. The article of claim 17 wherein each packet comprises an IP fragment and the order information comprises an offset value.

31. An apparatus comprising:
a memory system including a buffer memory to store packets delivered out-of-order by a network;
a processor, coupled to the memory system, to execute software to process the packets according to a protocol;
wherein the processor, when executing the software, maintains in the memory system data structures including a queue and a corresponding table;
wherein the processor, when executing the software, uses the table to place packets in the queue so that the packets are queued in order according to a sequence in which the packets were provided to the network by a sender.

32. The apparatus of claim 31 wherein the packets include sequence numbers, associated with the packets by the sender, usable to determine the sequence.

33. The apparatus of claim 32 wherein the queue comprises a linked list and the table divides the linked list into sublists at points in the linked list corresponding to gaps in the sequence.

34. The apparatus of claim 33 wherein each sublist is represented by an entry in the table.

35. The apparatus of claim 34 wherein the processor, when using the table, searches the table for each packet after such packet is received, the searching beginning with a first entry and continuing with each successive entry until a matching one of the entries, one usable to determine a location at which such packet is to be inserted into the queue linked list, is found.

36. The apparatus of claim 35 wherein the searching comprises, for each entry searched, examining the entry to determine if the packet should be included in the sublist represented by the entry.

37. The apparatus of claim 34 wherein the searching further comprises updating the entry to reflect the inclusion of the packet in the sublist.

38. The apparatus of claim 36 wherein the searching further comprises examining the entry to determine if the packet is to be added to the queue linked list as a new sublist that is adjacent to the sublist in the queue linked list.

39. The apparatus of claim 38 wherein searching further comprises updating the table to include a new entry to represent the new sublist.

40. The apparatus of claim 31 wherein each packet comprises a TCP segment.

41. The apparatus of claim 31 wherein the processor comprises a host CPU and the software comprises host operating system software.

42. The apparatus of claim 41 wherein the software comprises a TCP/IP stack.

43. The apparatus of claim 31 wherein the processor is a network processor having multiple threads of execution configurable to enable at least one of the threads of execution to execute the software.

44. An offload engine comprising:
a network device to interface to a network;
a memory system including a buffer memory to store packets delivered out-of-order by the network; and
a network processor comprising
a first interface connected to the network device to receive packets from the network;
a second interface to enable connection to a host system;
at least one processor, coupled to the memory system, to execute software to process the packets according to TCP;
wherein the at least one processor, when executing the software, maintains in the memory system data structures including a queue and a corresponding table; and
wherein the at least one processor, when executing the software, uses the table to place packets in the queue so that the packets are queued in order according to a sequence in which the packets were provided to the network by a sender.

45. The offload engine of claim 44 wherein the at least one processor comprises a first, general purpose processor to handle a control plane component of the TCP and a second processor to handle a data plane component of the TCP.

46. The offload engine of claim 45 where the software resides in the data plane component of the TCP.

47. The offload engine of claim 45 wherein the second processor comprises microengines each having threads of execution, and the software comprises microcode to execute on at least one thread of at least one microengine.
